(19) United States
(12) Patent Application Publication
(10) Pub. No.: US 2013/0173225 A1
(43) Pub. Date: Jul. 4, 2013

(54) METHOD FOR SAMPLING MESH MODELS AND APPARATUS FOR SAMPLING MESH MODELS

(71) Applicants: Kang Ying Cai, Beijing (CN); Wei Wei Li, Beijing (CN); Zhi Bo Chen, Beijing (CN)

(72) Inventors: Kang Ying Cai, Beijing (CN); Wei Wei Li, Beijing (CN); Zhi Bo Chen, Beijing (CN)

(73) Assignee: THOMSON LICENSING

(21) Appl. No.: 13/503,712

(22) PCT Filed: Apr. 29, 2011
(86) PCT No.: PCT/CN11/00757

§ 371 Date: Mar. 1, 2013

(51) Int. Cl. G06F 17/50

(52) U.S. Cl. CPC G06F 17/50
USPC 703/1

(57) ABSTRACT

Common 2D or 3D mesh models comprise redundancy in the form of symmetries, such as repetitive structures. For complexity reduction, the redundant structures must be detected. An improved method for sampling mesh models comprises sampling the model (710) using an initial sampling step size, detecting (720) a representative of a repeating structure, instances of the repeating structure and a remainder of the model, and sampling (780) the remainder and the representative using a first reduced sampling level according to a first reduced sampling step to size. The method comprises detecting (730) a size of said representative of a repeating structure, a size of the instances of the repeating structure and a size of said remainder, and calculating (740) the first reduced sampling step size based on the size of the instance and the total size of the model. The method can be repeated recursively.

### FIELD OF THE INVENTION

This invention relates to a method for sampling mesh models, and an apparatus for sampling mesh models.

### BACKGROUND

Repetitive structures are ubiquitous in nature, engineering and others. Repetitive structures are very common in man-made objects, and fundamental e.g. in almost all design styles in architecture. Therefore, all common types of 2D or 3D mesh models generally comprise repetitive structures. Due to increasing complexity of such models, it is desirable to minimize the amount of data required for coding them. Symmetry, including repetitive structures, is a kind of redundancy that may be used to reduce complexity: Repetitive structures need to be encoded only once, and can be called or “instantiated” several times. In order to benefit from this redundancy, it is necessary to detect repetitive structures in mesh models. Traditional methods use a technique for segmenting periodic structures that relies on a user to manually identify repetitive elements. Obviously such user assistance is unwanted. For the automatic detection of repetitive structures (also called repeating structures) in mesh models, only a subset of their vertices is used. Thus, the mesh models are sampled. The sampling step size is usually linearly reduced using a constant factor, e.g. a factor of 2. It is a problem how to detect all repetitive structures at various sizes within a mesh model with little processing effort. More details on sampling mesh models are described in the PCT application number PCT/CN2010/000984.

### SUMMARY OF THE INVENTION

The present invention is suitable for solving at least the above-mentioned problems, and provides an improved sampling method for mesh models, and a corresponding apparatus. The invention can equally be used at least for 2D mesh models or 3D mesh models.

According to the invention, a method for sampling mesh models comprises steps of sampling the model using an initial maximum sampling step size, detecting at least one representative of a repeating structure, at least one instance of the repeating structure and a remainder of the model, sampling the remainder and said at least one representative on a first reduced sampling level according to a first reduced sampling step size, and the steps of

detecting a size of said at least one representative of a repeating structure, a size of said at least one instance of the repeating structure and a size of said remainder, and calculating, based on the size of the instance and the total size of the model, said first reduced sampling step size.

An apparatus that utilizes the method is disclosed in claim 11.

In one embodiment, the mesh model is initially analyzed in order to determine an average edge length, and the average edge length is used to calculate at least a minimum sampling step size.

The invention is particularly suitable for improved detection of repeating structures and instances thereof in mesh models. Such detection of repeating structures and instances thereof is useful in several respects. It is particularly advantageous for improved encoding of mesh models, since instances of repeating structures can be encoded by a reference to their representative structure. Therefore, the invention also relates to an improved method for encoding mesh models, as disclosed in claim 9. A corresponding apparatus is disclosed in claim 12.

Advantageous embodiments of the invention are disclosed in the dependent claims, the following description and the figures.

### BRIEF DESCRIPTION OF THE DRAWINGS

Exemplary embodiments of the invention are described with reference to the accompanying drawings, which show in

FIG. 1 a block diagram of the method for sampling mesh models and discovering repetitive structures in sampled mesh models;

FIG. 2 the principle of symmetry detection;

FIG. 3 a tree structure for recording the detected multi-scale repetitive structure;

FIG. 4 a block diagram of a device for sampling mesh models and discovering repetitive structures;

FIG. 5 a block diagram of a detecting means for detecting repetitive structures;

FIG. 6 an exemplary 2D mesh model and its corresponding data set;

FIG. 7 a transformation between points of a point pair; and

FIG. 8 a block diagram of the method for recursively sampling mesh models.

### DETAILED DESCRIPTION OF THE INVENTION

The disclosed efficient method for sampling mesh models and detecting repetitive structures in mesh models can automatically discover repetitive structures of any small scale and multi-scale repetitive structures. The key ideas of the invention include iterative adaptive hierarchical sampling of mesh models, calculating individually decreasing sampling step sizes, and iteratively sampling the model with the decreased sampling step size. A block diagram of the method is shown in FIG. 1. The input data set for the algorithm can be a point set or a mesh model.

FIG. 1 shows an exemplary block diagram of a method for discovering repetitive structures in 2D or 3D mesh models. For an input model, sampling points are calculated 100, wherein a relatively large initial sampling step size is used. In the next steps, instances and representatives of repeating structures are detected. As one of several possible methods, a curvature based algorithm is used here. Exemplarily, a curvature descriptor is calculated for each sampling point in a curvature descriptor calculation step 200. The sampling points are clustered 300 according to their curvature descriptors, i.e. sampling points with similar curvature descriptors are put into the same cluster. Among the sampling points within a cluster, repetitive structures are detected (i.e. calculated) 400 and verified 500. From the detected repetitive structures, a tree is constructed where each repetitive structure is represented by a sub-branch. Then, sampling and detection of repetitive structure is recursively (at least once) repeated in order to find repeating structures on smaller scales. For this purpose, a reduced sampling step size is calculated 700 for each iteration. Finally, it is checked 800 whether the calculated reduced sampling step size is below a minimum sampling step size.

In the method of FIG. 1, an initial maximum sampling step size hₘₐₓ (i.e. distance between sampling points) is initially selected, the model is sampled with hₘₐₓ (i.e. sampling points are calculated 100), and representatives and instances of repeating structures as well as a remainder are detected 400. The calculation of the reduced sampling step size 700 is done as described in the following.

A minimum sampling step size hₘᵢₙ and a maximum sampling step size hₘₐₓ are pre-determined or calculated. We calculate hₘᵢₙ by hₘᵢₙ=S*e_{avg}, where S is a certain number and e_{avg} is the average edge length of the input model. The length is in a given unit according to the scale or coordinate system. S may be in the range of 2, . . . , Sₘₐₓ, where Sₘₐₓ, depends on the required spatial resolution. A useful value is S=3. The maximum sampling step size hₘₐₓ can be calculated so that there are at least N_{INIT} sampling points during the first iteration, where N_{INIT} is a certain number, e.g. 100. Or the maximum sampling step size hₘₐₓ can be calculated so that a maximum size of repeating structures can be covered, which may depend on the total size of the mesh model. Thus, hₘₐₓ can be calculated e.g. according to a diameter of the mesh model, e.g. max_diameter_of_model/4.

An initial sampling step decrease rate dᵢₙᵢₜ is selected. The sampling step decrease rate dᵢ is calculated newly after each iteration Thus, the sampling step sizes of the subsequent iterations hₘₐₓ, h₁, h₂, . . . , hᵢ, . . . , hₘᵢₙ are variably decreasing according to the current sampling step decrease rate d. Since the decrease rate d is re-calculated after each iteration, this means that the sampling step sizes are not decreased uniformly, but individually for each iteration. According to one embodiment of the invention, the sampling step decrease rate of each iteration dᵢ that determines the reduced sampling step size for the next iteration hᵢ according to hᵢ=hᵢ₋₁/dᵢ is calculated in principle from a ratio between a first size nᵢ and a second size nᵢ₋₁: the first size nᵢ is the accumulated size of the instances of repeating structures of the model at a sampling step size hᵢ during iteration i, and the second size nᵢ₋₁ is the accumulated size of the instances of repeating structures at a previous, larger sampling step size hᵢ₋₁, during a preceding iteration i−1. Thus, the sampling step decrease rate dᵢ and the sampling step size hᵢ for each iteration i is in principle calculated from a model decrease rate. For example, the sampling step size for the first iteration is calculated according to h₁=hₘₐₓ/dᵢₙᵢₜ.

In one embodiment, the sampling step decrease rate dᵢ and the sampling step size hᵢ for each iteration i is calculated from a current model decrease rate aᵢ, which depends on the input mᵢ of the i^{th} iteration and the input mᵢ₋₁ of the i−1^{th} iteration. “Input” means the number of vertices or triangles of the remaining model part, after discarding the instances of all repetitive structures discovered till then, or the surface area of such structure. Therefore, it also depends on the ratio between nᵢ₋₁ and nᵢ, as mentioned above, since nᵢ is the size of instances of all repetitive structures discovered during iterations up to iteration i. This will become clearer in the example given below.

Further, in one embodiment, a current model decrease rate aᵢ is calculated. Suppose aᵢ=mᵢ/mᵢ₋₁(aᵢ<1), where mᵢ is the input of the i^{th} iteration, i.e. the number of vertices or triangles of the remaining model part, after discarding the instances of all repetitive structures discovered till now, or the surface area of such structure. This number or area can only decrease from any one iteration to the next, but not increase, so that aᵢ cannot be greater than one. Further, aₘₐₓ=max (aᵢ), so that aₘₐₓ remains constant if in an iteration of level i the model decrease rate aᵢ is smaller than aₘₐₓ resulting from a previous iteration. Then d is chosen according to d=(C−aₘₐₓ)^{-1/n} with 0≦C≦1. In a particularly useful embodiment, C=1 and d is chosen according to d=(1−aₘₐₓ)^{-1/3}.

An example is given in Tab.1. It is explained as follows:

TABLE 1
Example 1 (m = number of vertices)

| i | nᵢ | mᵢ | aᵢ | aₘₐₓ | dᵢ | hᵢ | hᵢ > hₘᵢₙ? | h_{i, ex} |
|---|---|---|---|---|---|---|---|---|
| 0 | 1000 | 3000 | — | — | — | hₘₐₓ | y | 10 |
| 1 | 500 | 2000 | 0.67 | 0.67 | 1.4424 | h₁ = hₘₐₓ/1.4424 | y | 6.9333 |
| 2 | 400 | 1500 | 0.75 | 0.75 | 1.5949 | h₂ = h₁/1.5949 | y | 4.3472 |
| 3 | 550 | 1100 | 0.7333 | 0.75 | 1.5949 | h₃ = h₂/1.5949 | y | 2.7569 |
| 4 | 200 | 550 | 0.5 | 0.75 | 1.5949 | h₄ = h₃/1.5949 | y | 1.7259 |
| 5 | — | 350 | 0.6367 | 0.75 | 1.5949 | h₅ = h₄/1.5949 | n | 1.0821 |

In the example of Tab.1, it is assumed that a mesh model has 4000 vertices. After a first sampling with an initial sampling step size hₘₐₓ, e.g. h_{max,ex}=10, and a first repeating structure detection, it is determined that n₀=1000 of the vertices belong to instances of repeating structures, while m₀=3000 vertices belong to either the representative structures of the repeating structures or to the remainder of the model. The remainder comprises those parts of the model for which no repeating to structures have been found yet. Thus, the instances can be encoded by referencing (namely a reference to their representative structure), and need not be considered for the next iteration. Therefore, the input for the next iteration i=1 is 3000−1000=2000 vertices (m₁). The ratio a₁=m₁/m₀=0.67 determines the sampling step decrease rate dᵢ in this example according to d₁=(1−a₁)^{-1/3}=1,4424. Thus, the reduced sampling step size h₁ for the next iteration can be calculated to be h₁=hₘₐₓ/1,4424. In the example, h₁=10/1,4424=6,9333. The reduced sampling step size h₁ for the next iteration is compared with the above-described predetermined minimum sampling step size hₘᵢₙ, and is found to be greater than hₘᵢₙ.

In the next iteration, the m₁=2000 vertices are sampled using the reduced sampling step size h₁. Due to the reduced sampling step size, repeating structures of smaller scale can be discovered. This time, n₁=500 of the 2000 vertices belong to instances of repeating structures. Thus, using the same algorithm as above, a new ratio a₂=m₂/m₁=0.75 is determined. Since a₂>a₁, a new maximum value aₘₐₓ is determined to be 0.75. Thus, the sampling step decrease rate d₂ is adapted, and is obtained as above according to d₂=(1−a₂)^{-1/3}=1,5949. A new reduced sampling step size h₂ is calculated according to h₂=h₁/1,5949 (in the example, h_{2,ex}=6,933/1,5949=4,3472), compared with hₘᵢₙ and found to be greater than hₘᵢₙ. Therefore, a further iteration follows. The iterations end when the new reduced sampling step size is below hₘᵢₙ.

Tab.2 shows a corresponding example, which is based on surface areas instead of a number of vertices. That is, mᵢ denotes a surface area of a model that is input to iteration i, and nᵢ denotes accumulated surface areas of instances of repeating structures that are detected after sampling the input model in iteration i. As can be recognized, only two different sampling step decrease rates dᵢ are obtained in this example, namely 1,3572 and 1,6749.

TABLE 2
Example 2 (m = surface area of the input of i^{th} iteration)

| i | nᵢ | mᵢ | aᵢ | aₘₐₓ | dᵢ | hᵢ | hᵢ > hₘᵢₙ? | h_{i, ex} |
|---|---|---|---|---|---|---|---|---|
| 0 | 12 | 30 | — | — | — | hₘₐₓ | y | 10 |
| 1 | 7.3 | 18 | 0.6 | 0.6 | 1.3572 | h₁ = hₘₐₓ/1.3572 | y | 7.3681 |
| 2 | 6 | 10.7 | 0.5944 | 0.6 | 1.3572 | h₂ = h₁/1.3572 | y | 5.4288 |
| 3 | 1 | 4.7 | 0.4392 | 0.6 | 1.3572 | h₃ = h₂/1.3572 | y | 4 |
| 4 | 2 | 3.7 | 0.7872 | 0.7872 | 1.6749 | h₄ = h₃/1.6749 | y | 2.3882 |
| 5 | 0.7 | 1.7 | 0.4594 | 0.7872 | 1.6749 | h₅ = h₄/1.6749 | y | 1.4258 |
| 6 | — | 1.0 | 0.5882 | 0.7872 | 1.6749 | h₆ = h₅/1.6749 | n | 0.8513 |

The following terminology has been used.
hᵢ₊₁=hᵢ/d is the distance between sampling points (sampling step size).
d=(1−aₘₐₓ)^{-1/3} is the sampling step decrease rate.
nᵢ is the number of vertices/triangles of repeating structure instances discovered during current iteration (or the surface area of such structures).
mᵢ=mᵢ₋₁−nᵢ₋₁ is the number of the vertices or triangles of the repetitive structure representatives and of the model part that does not include any repetitive structures after i−1 iterations (or the surface area of such structures).
aᵢ=mᵢ/mᵢ₋₁ is the current decrease rate of the iteration input model.
aₘₐₓ is the current maximum decrease rate of previous or current iterations.

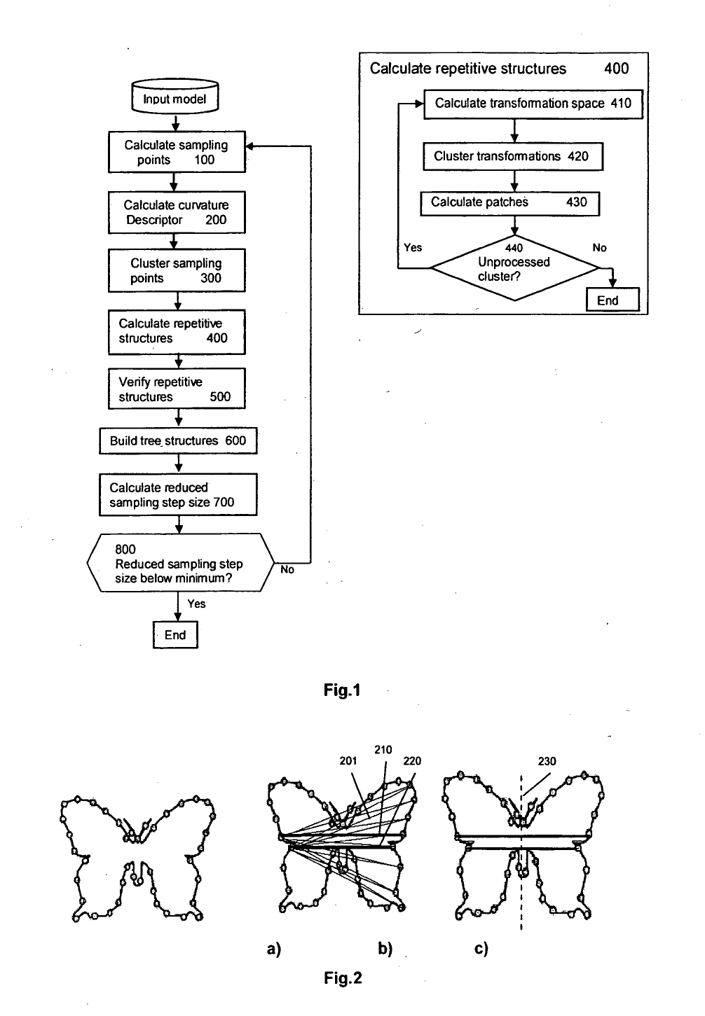

FIG. 2 shows an example of a 2D mesh model. While in a) the sampling points referring to a particular step size are shown, b) shows possible transformations that can be constructed: For each sampling point, a transformation to each other sampling point is calculated. In one embodiment, such transformations are calculated only for point pairs that have similar curvature, such as 201,210,220. After clustering, those transformations that relate to a real symmetry can be identified, since they are so similar that they end up in a common transformation cluster. In FIG. 2 c), the determined symmetry of this exemplary model is shown: a reflection on a symmetry axis 230. Thus, the model can be encoded by one reference (namely one side of the model) and one instance of the reference (namely the other side of the model), which reduces the number of points (vertices) to be encoded by 50%. In this particular example, there is no remainder at least in the first iteration. Further symmetries that can be encoded using references and instances can be detected in subsequent sampling levels at is reduced sampling step sizes, as described above.

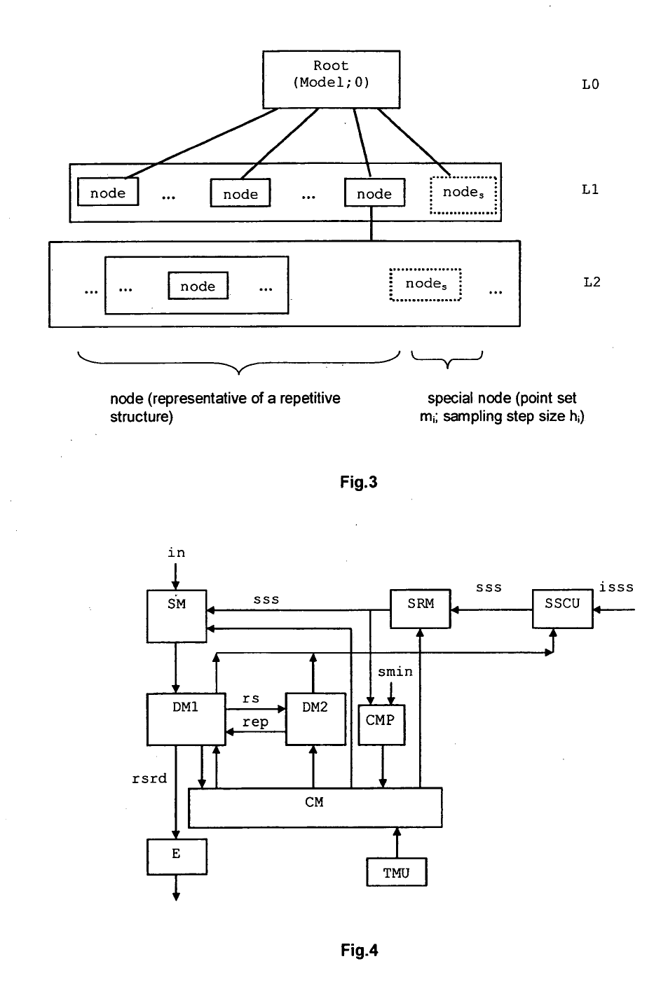

For recording the multi-scale repetitive structures detected by the method, a tree structure can be used, as shown in FIG. 3. Each node of the tree, except the special nodes nₛ, records one repetitive structure. Each instance of a repetitive structure is not recorded in the tree directly, but as a reference to a leaf. Initially, the tree has only the root, corresponding to the input model. The sampling step h is initially a relatively large number. After each sampling step size level L, the tree structure which records the detected multi-scale repetitive structure is updated. The repetitive structures just detected are added as leafs of the corresponding node. The size of all just detected instances of repetitive structures is determined. One special leaf node nₛ is added, which corresponds to the part of surface that does not contain any repetitive structure. This part is called remainder of the model. Like any representative of a repetitive structure, the remainder may comprise smaller scale repetitive structures, which will be detected in one of the next iterations of the algorithm. Then, a reduced sampling step size for the next iteration is calculated, as described above. In the next iteration, the calculated reduced sampling step size will be used for sampling. The algorithm may deal with all the leaf nodes separately. The algorithm is stopped when the sampling step is smaller than a threshold.

Since symmetry is an important concept for the invention, it is clarified here that symmetry means invariance under a set of transformations, such as rotations, translations, reflections and uniform scaling. That is, repeating structures can be determined independently from size, position and orientation of the instances, as described in the above-mentioned PCT application.

Further, mᵢ (the input of i^{th} iteration) is the data needed to represent the input model based on the current repetitive structure discovery result, i.e. input model without the instances of all repetitive structures discovered till the (i−1)^{th} iteration. This is to be distinguished from all repetitive structure representatives discovered till the (i−1)^{th} iteration. FIG. 6 shows an example of data defining the repetitive structures and the remaining data portions of an exemplary 3D mesh model. It is pointed out here that this is a simplified example for explaining a basic principle of one embodiment. In FIG. 6, a 2D mesh model comprises one repetitive triangular structure that is used several times and a circular remainder rm that is not a repetitive structure. The data rsrd comprise sampling data rrd1 of a representative structure rr of the repetitive structure, and repetition data r1,r2, . . . indicating individual repetitions thereof and their respective transformations tr1(rrd1), tr2(rrd1), . . . for defining the position, scale etc. of each repetition. Further, the data rsrd comprise sampling data rmd1 defining the remainder. While in this example the remainder is only one single structure, it may also be two or more individual sub-structures.

As long as the sampling step size is above the threshold hₘᵢₙ, at least the model part without any repetitive structures is further processed, as it could include smaller repetitive structures. Further, also the repetitive structure representative that was discovered before the (i−1)^{th} iteration could be replaced by representatives of smaller repetitive structures it includes and is input to the i^{th} iteration. The vertex/triangle number or surface area of repetitive structures may be a better choice for evaluating the input of each iteration than the repetitive structure number, as various repetitive structures may vary dramatically in vertex/triangle number or surface area.

FIG. 4 shows a device for detecting repetitive structures in 3D mesh models according to one embodiment of the invention. It comprises sampling means SM, i.e. a sampling unit, for sampling the 2D or 3D mesh model provided at the input in. It uses a current sampling step size sss that it receives from a sampling step calculation unit SSCU, as described below. It is generally to be noted that the sampling step size is uniform within one sampling level, and that if a sampling step sizes is a fractional number (not an integer), the virtual sampling point between vertices will be replaced by the nearest vertex, since the sampling points are always vertices of the model.

The sampling unit SM provides sampled data to a detection means DM1, which detects within the sampled mesh model one or more repetitive structures and identifies remaining portions of the model that are no repetitive structures. Each repetitive structure rs is provided to a determining means DM2, which determines a representative rep for each of the one or more repetitive structures and provides input to the sampling step calculation unit SSCU for calculating the next sampling step size. The representative (i.e. its data) is provided back to the detecting means DM1, which uses it for identifying (further) repetitions thereof, using a re-sampled model according to the updated sampling step size sss.

Sampling and control data of repetitive structures and the above-mentioned remaining data portions rsrd are provided as output, e.g. to an encoder E. These data rsrd comprise sampling data of a representative for each repetitive structure and of each remaining portion, having the sampling step size in which they were sampled. The data rsrd also comprise data defining the repetitions of the repetitive structures. An example is given above with respect to FIG. 6.

Further, the device has control means CM for controlling, as long as the detection means detects one or more repetitive structures using the current sampling step size, a repeated operation of the device. That is, if the detecting means DM1 signals to the control means CM that it has finished its operation on a model and that it has identified at least one repetitive structure, then the control means CM controls a sampling step size reducing means SRM to reduce the sampling step size. Further, the control means CM controls the sampling means SM, the detecting means DM1 and the determining means DM2 to repeat their operation for each detected representative of a detected repetitive structure and for the remaining portions of the model, using the reduced sampling step size.

The sampling step size is initially a pre-defined value isss, and is successively reduced by an adaptive factor, as explained above. This factor is an adaptive variable that depends on the size of instances of repeating structures. That is, while in a first iteration the sampling step size is the pre-defined value isss, it may be isss/d₁ in a second iteration, isss/d₂ in a third iteration, isss/d₃ in a fourth iteration etc. with d₃<d₂<d₁. That is, the sampling step size decrease rate d itself is always growing or constant from iteration to iteration, but not decreasing. Note that second and further iterations are only performed for representatives of a repetitive structure and for remainders.

If the detecting means DM1 does not detect any more repetitive structures, or if a pre-defined minimum sampling step size sₘᵢₙ (or a time-out) is reached, the device for detecting repetitive structures is stopped. For this purpose, the device comprises, in one embodiment, a time-out measurement unit TMU, and in one embodiment a sampling step size comparison unit CMP.

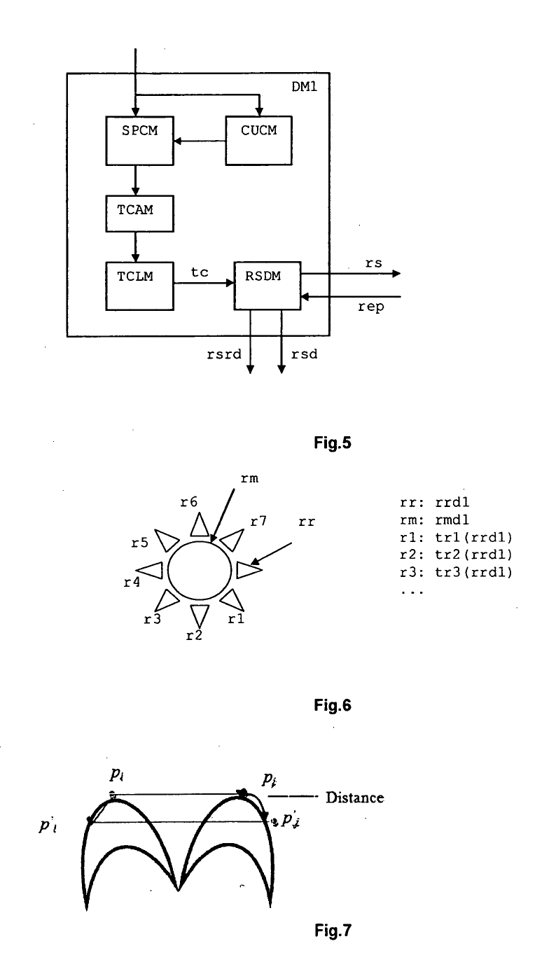

FIG. 5 shows details of one embodiment of the detecting means DM1. It comprises curvature calculating means CUCM for calculating a curvature descriptor for each sampling point, based on the respective current sampling step size. Curvature descriptors are described above. A sampling point clustering means SPCM clusters the sampling points according to their curvature descriptor, wherein one or more sampling point clusters are provided. Transformation calculating means TCAM is used for calculating transformations between pairs of sampling points that belong to a common sampling point cluster, and transformation clustering means TCLM is used for clustering the calculated transformations. This is done in a transformation space, and results in one or more transformation clusters tc being provided. Finally, the detecting means DM1 comprises repetitive structure determining means RSDM for determining, according to each of the one or more transformation clusters in the transformation space, a repetitive structure rs, wherein pairs of sampling points whose transformation belongs to a common cluster in the transformation space are defined as two instances of a repetitive structure. The repetitive structure rs is provided to the above-mentioned determining means DM2, which determines (i.e. identifies) a representative rep for the repetitive structure. This may happen in any arbitrary manner, e.g. the first determined instance of a repetitive structure is selected as representative, and all further instances are selected as repetitions. The repetitive structure determining means RSDM outputs first data rsrd defining the whole model, as described below, and second data rsd indicating whether or not at least one repetitive structure has been found. The latter data rsd is provided to the control block CM, which may decide to initiate another iteration.

In one embodiment, the detected multi-scale repetitive structure is recorded as a tree structure in a memory device.

FIG. 7 shows a transformation between points of a point pair. (pᵢ,pⱼ) is a point pair of Cₖ, and T_{i,j} is the transformation between them. p′ᵢ is a one-ring neighbour of pᵢ. Transforming p′ᵢ by T_{i,j} can obtain p′ⱼ. That is: if the p′ᵢ after transformation is close to the actual p′ⱼ (e.g. within a threshold circle), the transform T_{i,j} is a good candidate. If the transform T_{i,j} is a good candidate for several points, it is used for determining a symmetry.

Discovering repetitive structures in mesh models is a challenging task, but the result is very useful in many aspects. The described method and device can e.g. be used for 3D model compression, 3D model repairing, geometry synthesis etc.

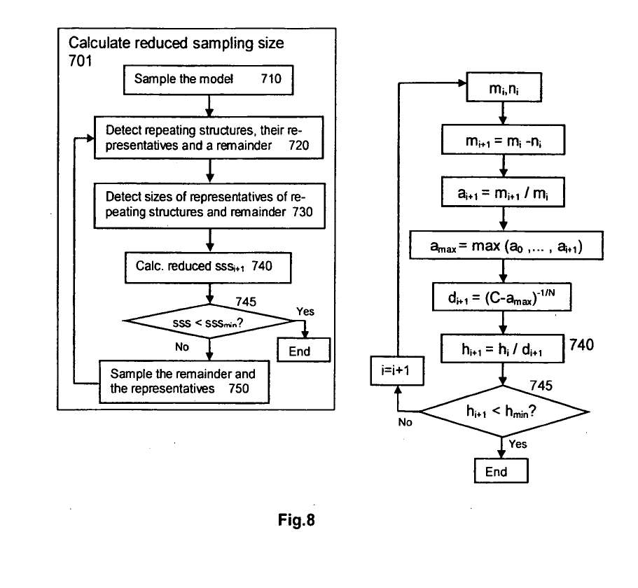

FIG. 8 shows a block diagram of a method for sampling mesh models. It comprises steps of sampling the model 710 using an initial maximum sampling step size, detecting 720 at least one representative of a repeating structure, at least one instance of the repeating structure and a remainder of the model, sampling 750 the remainder and said at least one representative on a first reduced sampling level according to a first reduced sampling step size. Further steps are detecting 730 a size of said at least one representative of a repeating structure, a size of said at least one instance of the repeating structure and a size of said remainder, and calculating 740 said first reduced sampling step size. The calculating step 740 is based on the size of the instances nᵢ and the total size of the model mᵢ, as described above.

FIG. 8 further shows a flow-chart of a method for recursively determining the reduced sampling step size hᵢ₊₁, as described above. The method requires predefined values for C and N for the calculation of the sampling step decrease rate d (in the above example, C=1 and N=3), and begins with an index i=0. Further, a is value for the initial sampling step size h₀=hₘₐₓ is pre-defined and a value for the minimum sampling step size is determined as described above. The method ends when hᵢ₊₁<hₘᵢₙ or when hᵢ₊₁≦hₘᵢₙ.

It is an advantage of the present invention that the initialization parameters, procedure parameters (such as sampling step decrease rate) and termination parameters (such as hₘᵢₙ) for automatic sampling of mesh models can be automatically determined.

In one aspect, a method for sampling mesh models comprises steps of selecting a maximum sampling step size (coarse sampling) and a minimum sampling step size (according to average edge length of the 3D mesh model), sampling the model using the maximum sampling step size, detecting at least one representative of a repeating structure, at least one instance of the repeating structure and a remainder of the model, determining the size of the instance, calculating, based on the size of the instance and the size of the model, a reduced sampling step size, comparing the reduced sampling step size with the minimum sampling step size, and if the reduced sampling step size is above the minimum sampling step size then performing the steps of sampling the remainder and said at least one representative on a reduced sampling level according to the reduced sampling step size, detecting at least one representative of a repeating structure at the reduced sampling level, at least one instance of the repeating structure at the reduced sampling level and a remainder of the model at the reduced sampling level; and if the reduced sampling step size is not above the minimum sampling step size then terminating the method.

In one aspect, the invention can be implemented by a computer readable storage medium having executable instructions to cause a computer to perform one of the methods as described above. E.g. it may be a method for sampling a mesh model, comprising steps of sampling the model using an initial maximum sampling step size, detecting at least one representative of a repeating structure, at least one instance of the repeating structure and a remainder of the model, sampling the remainder and said at least one representative on a first reduced sampling level according to a first reduced sampling step size, and the steps of detecting a size of said at least one representative of a repeating structure, a size of said at least one instance of the repeating structure and a size of said remainder, and calculating, based on the size of the instance and the total size of the model, said first reduced sampling step size.

It should be noted that although methods and devices are described for either 2D or 3D mesh models, all methods and devices can adapted for usage with 2D as well as 3D mesh models, as would be apparent to those of ordinary skill in the art, all of which are contemplated within the spirit and scope of the invention. It will be understood that the present invention has been described purely by way of example, and modifications of detail can be made without departing from the scope of the invention. Each feature disclosed in the description and (where appropriate) the claims and drawings may be provided independently or in any appropriate combination. Features may, where appropriate be implemented in hardware, software, or a combination of the two. Connections may, where applicable, be implemented as wireless connections or wired, not necessarily direct or dedicated, connections. Reference numerals appearing in the claims are by way of illustration only and shall have no limiting effect on the scope of the claims.

1. A method for sampling mesh models, comprising steps of
sampling the model (710) using an initial maximum sampling step size;
detecting (720) at least one representative of a repeating structure, at least one instance of the repeating structure and a remainder of the model;
sampling (750) the remainder and said at least one representative on a first reduced sampling level according to a first reduced sampling step size;
characterized in the steps of
detecting (730) a size of said at least one representative of a repeating structure, a size of said at least one instance of the repeating structure and a size of said remainder; and
calculating (740), based on the size of the instance and the total size of the model, said first reduced sampling step size.

2. Method according to claim 1, further comprising, after said step of sampling the remainder and said at least one representative on the first reduced sampling level according to the first reduced sampling step size, the following steps:
detecting at least one representative of a repeating structure at the first reduced sampling level, at least one instance of the repeating structure at the first reduced sampling level and a remainder of the model at the first reduced sampling level;
determining a size of said at least one representative of a repeating structure at the first reduced sampling level, a size of said at least one instance of the repeating structure at the first reduced sampling level and a size of a remainder of the model at the first reduced sampling level;
calculating, based on said first reduced sampling level and the size of the instance and the size of the model at the first reduced sampling level, a second reduced sampling step size;
comparing the second reduced sampling step size with a minimum sampling step size; and
if the second reduced sampling step size is above the minimum sampling step size, sampling the model at a second reduced sampling level according to the second reduced sampling step size, detecting sizes of at least one representative of a repeating structure, at least one instance of the repeating structure and a remainder of the model at said second reduced sampling level, calculating a reduction factor and reducing the second reduced sampling step size by said reduction factor, wherein a third reduced sampling step size is obtained;
if the second reduced sampling step size is not above the minimum sampling step size, terminating the sampling.

3. Method according to any of claims 1-2, wherein a reduced sampling step size hᵢ is calculated by dividing a previous sampling step size hᵢ₋₁ by a factor dᵢ according to hᵢ=hᵢ₋₁/dᵢ, the factor dᵢ being calculated from a ratio aᵢ between a first size nᵢ and a second size nᵢ₋₁ and being greater than one, wherein the first size nᵢ is the accumulated size of the instances of repeating structures of the model at a current sampling step size, and the second size nᵢ₋₁ is the accumulated size of the instances of repeating structures at a previous, larger sampling step size.

4. Method according to any of claims 1-2, wherein a reduced sampling step size hᵢ is calculated by dividing a previous sampling step size hᵢ₋₁ by a factor dᵢ according to hᵢ=hᵢ₋₁/dᵢ, the factor dᵢ being calculated from a ratio aᵢ between a first size mᵢ and a second size mᵢ₋₁ and being greater than one, wherein the first size mᵢ is the accumulated size of the representatives of repeating structures and the remainder of the model at a current sampling step size, and the second size mᵢ₋₁ is the size of the representatives of repeating structures and the remainder of the model at a previous, larger sampling step size.

5. Method according to claim 4, wherein the factor dᵢ is calculated from said ratio aᵢ according to dᵢ=(1−aᵢ)^{-1/N} with N being an integer greater than 1.

6. Method according to one of the claims 3-5, wherein for said ratio aᵢ between the first size mᵢ and the second size mᵢ₋₁ the maximum value aₘₐₓ of the ratios of previous or current iterations is used.

7. Method according to any of claims 1-6, wherein the size is given according to a number of vertices.

8. Method according to any of claims 1-7, wherein the size is given according to a surface area.

9. Method according to any of claims 1-8, further comprising initial steps of
analyzing the mesh model, wherein an average edge length e_{avg} is determined; and
calculating at least the minimum sampling step size hₘᵢₙ from the average edge length e_{avg} according to hₘᵢₙ=hₘᵢₙ*K with K being greater than 1.

10. A method for encoding mesh models, comprising steps of
a first sampling step for sampling the model using a first sampling step size;
detecting at least one first repeating structure, a representative and at least one instance of the at least one first repeating structure and a first remainder of the model;
a second sampling step for sampling the first remainder and said representative of the at least one first repeating structure on a first reduced sampling level according to a first reduced sampling step size, wherein said at least one instance of the at least one first repeating structure is not sampled;
detecting at the first reduced sampling level at least one second repeating structure, a representative and at least one instance of the at least one second repeating structure, and a second remainder of the model; and
encoding the mesh model, wherein the second remainder of the model and said first and second representatives of repeating structures are encoded, and wherein said at least two instances of the first and the second repeating structures are encoded only by references to said repeating structures;
characterized in the steps of
detecting a first size being a total size of the mesh model sampled in the first sampling step, and a second size being a size of said first remainder and the at least one representative of the at least one first repeating structure sampled in the second sampling step; and
calculating said first reduced sampling step size, based on the first size and the second size.

11. Method according to claim 10, wherein said first reduced sampling step size is calculated from a ratio between the first size and the second size.

12. An apparatus for sampling mesh models, comprising
first sampling means for sampling the model using an initial maximum sampling step size;
analyzing and detecting means for detecting at least one representative of a repeating structure, at least one instance of the repeating structure and a remainder of the model;
second sampling means for sampling the remainder and said at least one representative on a first reduced sampling level according to a first reduced sampling step size;
characterized in that the apparatus further comprises
size detecting means for detecting a size of said at least one representative of a repeating structure, a size of said at least one instance of the repeating structure and a size of said remainder; and
calculating means for calculating, based on the size of the instance and the total size of the model, said first reduced sampling step size.

13. An apparatus for encoding mesh models, comprising
first sampling means for sampling the model using a first sampling step size;
first analyzing and detecting means for detecting at least one first repeating structure, a representative and at least one instance of the at least one first repeating structure and a first remainder of the model;
second sampling means for sampling the first remainder and said representative of the at least one first repeating structure on a first reduced sampling level according to a first reduced sampling step size, wherein said at least one instance of the at least one first repeating structure is not sampled;
second analyzing and detecting means for detecting at the first reduced sampling level at least one second repeating structure, a representative and at least one instance of the at least one second repeating structure, and a second remainder of the model; and
encoder for encoding the mesh model, wherein the second remainder of the model and said first and second representatives of repeating structures are encoded, and wherein said at least two instances of the first and the second repeating structures are encoded only by references to said repeating structures;
characterized in that the apparatus comprises
size detecting means for detecting a first size being a total size of the mesh model sampled in the first sampling step, and a second size being a size of said first remainder and the at least one representative of the at least one first repeating structure sampled in the second sampling step; and
calculating means for calculating said first reduced sampling step size, based on the first size and the second size.

14. Apparatus according to claim 12 or 13, wherein a reduced sampling step size hᵢ is calculated by dividing a previous sampling step size hᵢ₋₁ by a factor dᵢ according to hᵢ=hᵢ₋₁/dᵢ, the factor dᵢ being calculated from a ratio aᵢ between a first size nᵢ and a second size nᵢ₋₁ and being greater than one, wherein the first size nᵢ is the accumulated size of the at least one instance of said at least one first repeating structure, and the second size nᵢ₋₁ is the accumulated size of the at least one instance of said at least one second repeating structures.

15. Apparatus according to any of the claims 12-14, wherein the size is given according to a number of vertices.
